(19) United States
(12) Patent Application Publication
(10) Pub. No.: US 2009/0055772 A1
(43) Pub. Date: Feb. 26, 2009

(54) SYSTEMS AND METHODS FOR ACCESSING A PHOTO PRINT SERVICE THROUGH A PRINTER DRIVER

(76) Inventor: Qiang Huang, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/933,976

(22) Filed: Nov. 1, 2007

Related U.S. Application Data
(60) Provisional application No. 60/965,614, filed on Aug. 20, 2007.

(51) Int. Cl. G06F 3/048; G06F 13/00; G06F 17/00

(52) U.S. Cl. 715/810; 719/321; 707/100; 707/E17.002

(57) ABSTRACT

Systems and methods are provided for uploading image files such as photos for printing to a photo printing service using a printer driver. A typical system in one aspect includes a client device having one or more processors, one or more memory devices for storing image files, applications and other computer readable instructions, a network interface device, and one or more I/O ports for communicating with various I/O devices and an external display device such as a monitor to access a photo print service through a virtual printer driver. In another aspect, the computer readable program code instructions include a printer driver module that provides virtual photo printing services to a user of the client device.

### BACKGROUND

The present invention relates generally to digital delivery of image files to a photo printing server, and more particularly to delivering image files to a photo printing service over a network through a printer driver.

There are a lot of photo printing services well known in the art. The benefit to existing solutions is that the customers do not need a photo printer at home. Also, using an online photo printing service is often cheaper than the cost of at-home printing with better quality, for all photo sizes. There are two typical ways of providing a printing service: a web upload and through specialized applications built into existing software.

Web upload. The users must use the service's website to upload the photos. This process is often time-consuming, due to the large file size of the photos, and limited uplink speed of home-based internet connections. Most printing services use this method.

Specialized functionalities built-in an application. For example, Apple's iPhoto has special Export dialogs for uploading to retailers such as Walmart and Walgreens for printing. Using this type of system, the workflow is more seamless than using a standard web upload. However, each application must add the functionality in its programming, and users are limited to the printing service supported by the application.

Other relevant specialized functionalities built in an application include print-to-file and online fax services that are well known in the art. Print-to-file is a common technique used to generate certain file formats, like PDF or JPEG. Some online fax service (for example, fax1.com) utilize print drivers. However, there are essential differences between faxing and photo printing. The photo printing methodology involves multiple paper sizes, as well as physical media delivery or pick-up options. Users have a limited ability to transfer files through a plurality of applications and file formats.

Therefore it is desirable to provide a photo printing service system and method including a virtual printer driver that overcomes the above and other problems. In particular, many previous solutions requires particular file format, which requires the users to go through export process before sending the photo for printing.

### BRIEF SUMMARY

Systems and methods are provided by embodiments for sending image files to a remote photo printing service from a client device where the client device stores one or more image files. In one embodiment a method comprises a) providing a virtual printer driver module, wherein the printer driver module executes on a processor of the client device; b) receiving, at the printer driver module, a user input print job request identifying one or more digital image and a printing service; and c) uploading the one or more digital image files to the photo printing service over a network connection using the virtual printer driver module.

Another embodiment provides a method further comprising printing the digital image files at the photo printing service provider through the use of either in house printing devices or affiliate photographic laboratory printers.

In another embodiment, a method is provided wherein uploading executes as a background process, allowing a user to complete other tasks while a print job is pending without occupying a workstation from other applications or work.

In another embodiment, a computer readable medium is provided that comprises program code for providing a printer driver module, wherein the printer driver module executes on a processor of the client device. The computer readable medium further provides program code for receiving, at the printer driver module, a user input print job request identifying one or more digital image files and a printing service. Also, program code for uploading the one or more digital image files to the photo printing service over a network connection using the printer driver module is provided in the computer readable medium embodiment.

In a related embodiment, a computer readable medium is provided for sending image files to a remote photo printing service from a client device, said client device storing one or more image files, comprising a) program code for providing a printer driver module, wherein the printer driver module executes on a processor of the client device; b) program code for receiving, at the printer driver module, a user input print job request identifying one or more digital image files and a printing service; and c) program code for uploading the one or more digital image files to the photo printing service over a network connection using the printer driver module.

In other computer readable medium embodiments, further program code is provided including program code for directly encoding and uploading digital image file such that no file formatting or exporting is required. Also, program code for providing physical photo printing services is provided wherein the print commands execute a set of printing instructions via a print command language on a print spooler and a port listener; and program code for executing the physical photo printing services independently of the uploaded file format. In addition, program code is provided for executing the physical photo printing services such that one or more print jobs perform instructions as a background process. Program code is further provided for printing directly in response to translated instructions from a print spooler and port listener and program code provides physical photo printing services in a user selected image file format. Also, program code is provided to facilitate a means of selection of one or more print jobs from a pending print job menu and for canceling the print job in response to a user selection.

In a related embodiment, A client system is provided comprising a processor and the computer readable medium wherein the processor executes the program code.

In a related embodiment, a computer system provides a virtual photo printing service, the system including a memory containing predetermined instructions and one or more data structures, a processing unit operatively coupled to the memory and capable of executing the predetermined instructions, an output device operatively coupled to the memory and the processing unit, wherein the processing unit executes the predetermined instructions to a) provide a printer driver module, wherein the printer driver module executes on a processor of the client device; b) receive, at the printer driver module, a user input print job request identifying one or more digital image files and a printing service; and c) upload the one or more digital image files to the photo printing service over a network connection using the printer driver module.

### BRIEF DESCRIPTION OF DRAWINGS

FIG. 1 illustrates an overview embodiment of the photo printing service with a print driver method.

FIG. 2 illustrates an embodiment including an application method from the user perspective.

FIG. 3 shows a user interface screen shot of a method to select a photo printing service as a printer.

FIG. 4 illustrates an embodiment including a user interface example showing photo paper options in a print dialog view.

FIG. 5 illustrates an embodiment including a method to send an image to a server, handled by a port listener.

FIG. 6 illustrates an embodiment of an interface method to obtain service options.

FIG. 7 shows an embodiment including a user interface screen shot of a method to log in to an account.

FIG. 8 shows an embodiment including a user interface screen shot of a method to create a new account.

FIG. 9 shows an embodiment including a user interface screen shot of a method to enter a user credit card information.

FIG. 10 shows an embodiment including a user interface screen shot of a method to enter a delivery option to have photos delivered to a specified location.

FIG. 11 shows an embodiment including a user interface screen shot of a method to enter a delivery option to have photos picked up by a user or third party at a specified location.

FIG. 12 illustrates a method of client printing wherein the specified photos are delivered to a user specified location.

FIG. 13 illustrates a method of retrieving a batch of photos for delivery to a user specified location.

FIG. 14 illustrates a method of client printing wherein the specified photos are available for user to pick up at a specified location.

FIG. 15 illustrates a method of retrieving a batch of photos for delivery upon receiving a message from a pick-up station ID.

FIG. 16 illustrates an illustrative embodiment of a typical system operating environment to provide photo printing service with a print driver.

### DETAILED DESCRIPTION OF DRAWINGS

### General System Overview

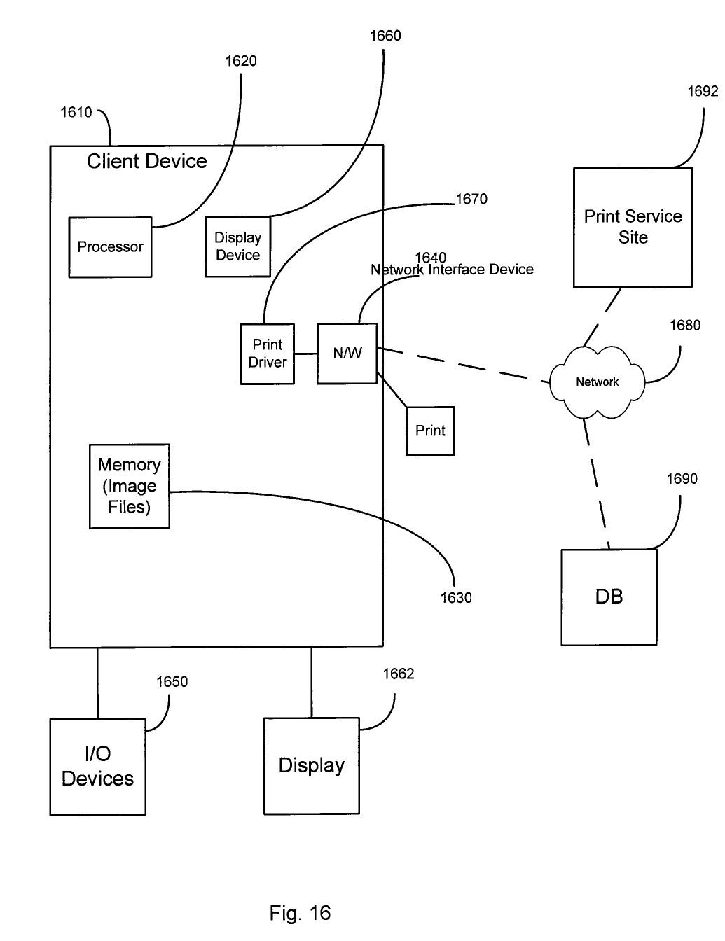

The embodiments of the enclosed invention introduce new systems and methods for uploading image files such as photos for printing to a photo printing service using a printer driver. FIG. 16 shows a typical system 1600 according to one embodiment that includes a client device 1610 having one or more processors 1620, one or more memory devices for storing image files 1630, applications and other computer readable instructions, a network interface device 1640, and one or more I/O ports for communicating with various I/O devices 1650 and an external display device 1660 such as a monitor 1662. In one embodiment, said instructions include a printer driver module 1670 that provides virtual photo printing service to a user of the client device.

An exemplary printer driver instruction set might include, variously, instructions to access a print service site over a network 1680, instructions to access an information database 1690 over a network, instructions to receive or retrieve information about one or more printing services 1692, and/or instructions to process any received photo printing service requests from a user. Processing can include, merely by way of example, accessing image files to be uploaded to a print service site, converting the file type of an image file and, transferring the image files from the client computer (e.g., via a network connection) to the print service using the printer driver.

An exemplary computer hardware system more generally further includes a typical hardware setup for executing software that allows a user to perform tasks such as communicating with other computers, accessing various computer resources, and viewing, creating, or otherwise manipulating electronic content such as a text, images, movies, music, animations, 3D virtual worlds, and links to other objects. The system also includes various input/output (I/O) devices such as a mouse, keyboard, display, and a general purpose computer having a central processor unit, an I/O unit, a memory that stores data and various programs such as an operating system, and one or more application programs. The computer system also typically includes non-volatile memory such as RAM, a hard disk drive, various removable storage media drives for receiving portable computer readable media such as CDs or DVDs, and a communications card or device for exchanging data with a network via a communications link. The computer can also be connected to various peripheral I/O devices such as a digital camera that enables users to take pictures and save them in digital format.

A traditional digital camera enables users to take pictures which are saved in memory within the digital camera in a digital format. After taking and storing the images, the user can connect the digital camera to a computer system in order to upload the digital images to the computer's disk drive or other non-volatile memory. Once the digital images are uploaded to the computer system, the user can erase the digital images from the memory of the digital camera so that the user can take and store additional images using the digital camera. Typically, the digital camera is connected to the computer only while the user is uploading images to the computer's disk drive or other non-volatile memory. Users can also obtain digital images of film-based prints by sending an exposed film into a photo-finishing service, which develops the film to make prints and then scans or otherwise digitizes the prints to generate digital files. The digital image files can then be transmitted back to the user by e-mail or provided on a CD-ROM, or other removable storage medium.

### Print Service Access Using a Printer Driver

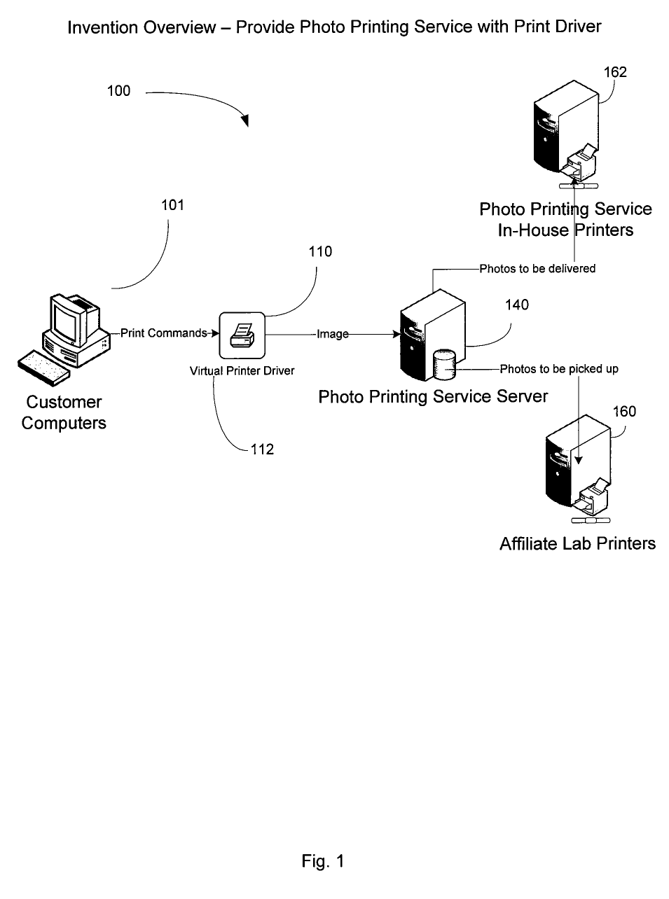

According to one embodiment as shown in FIG. 1, an overall system overview 100 is illustrated. A printer driver 110 is provided that behaves like a virtual photo printer 112 and allows users to upload image files to be printed at remote print service locations 160, 162. Like a regular printer driver, the user is presented with options to select or set the number of prints, page range (if there are multiple photos), and other photo related options (not shown in FIG. 1). The printer driver also allows the user to select paper size (e.g. 4×6, 5×7, 8×10, 11×17 and other sizes). Since the photo's native aspect ratio may not match the paper size, the printer driver will also allow the user to specify whether to scale or trim the photo. Other options include bordered versus borderless printing, and other photo related options. In short, the user will see a regular photo printer driver 110. In addition, the printer driver contains the settings to the membership information at one or more photo printing services. For example, the user may need to select or enter account ID and password information, pick-up or delivery location options, and payment information. A photo printing service server 140 will transmit a message to either an affiliate lab printing location 160 where the photos can be picked up or a photo printing service in-house printer 162 where the photos will be delivered.

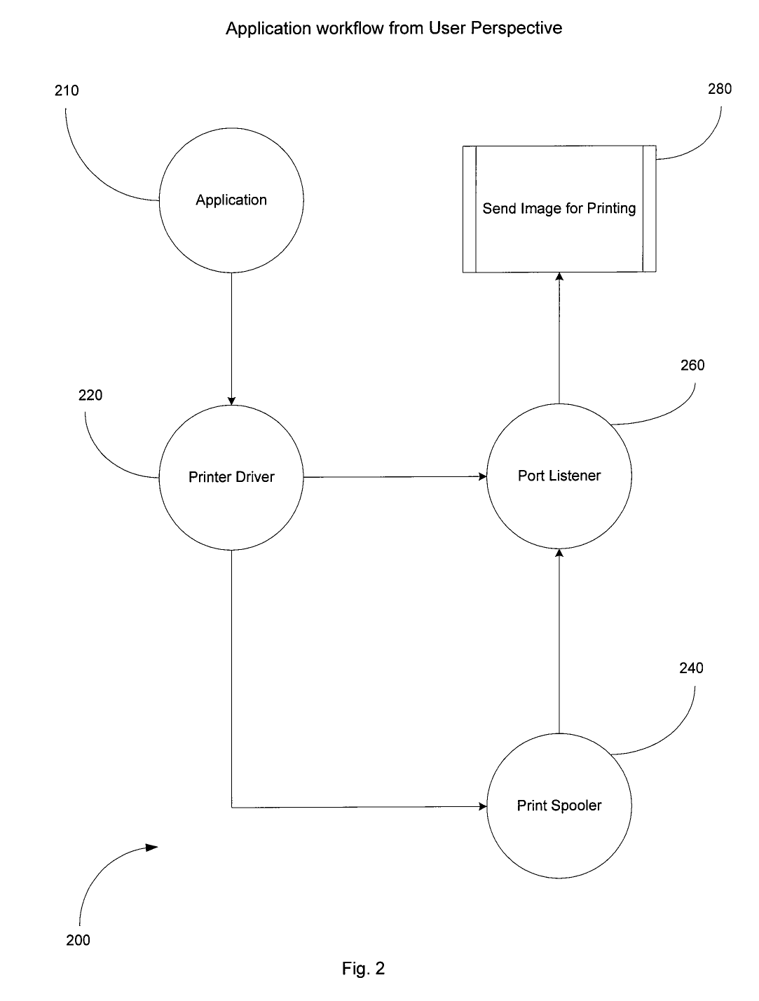

FIG. 2 illustrates the method from the user perspective 200. When the user prints with the virtual photo printer, the image is saved to a user's local machine as a temporary file via one or more user applications 210 and then uploaded over a network connection to the selected service in the background with the print spooler 240, just like a regular printer. If necessary the printer driver 220 converts the image file format to a format supported by the selected service by utilizing a port listener 260 before sending the images for printing to a print location 280. The user is able to cancel any unfinished printing jobs in the printer spooler 240.

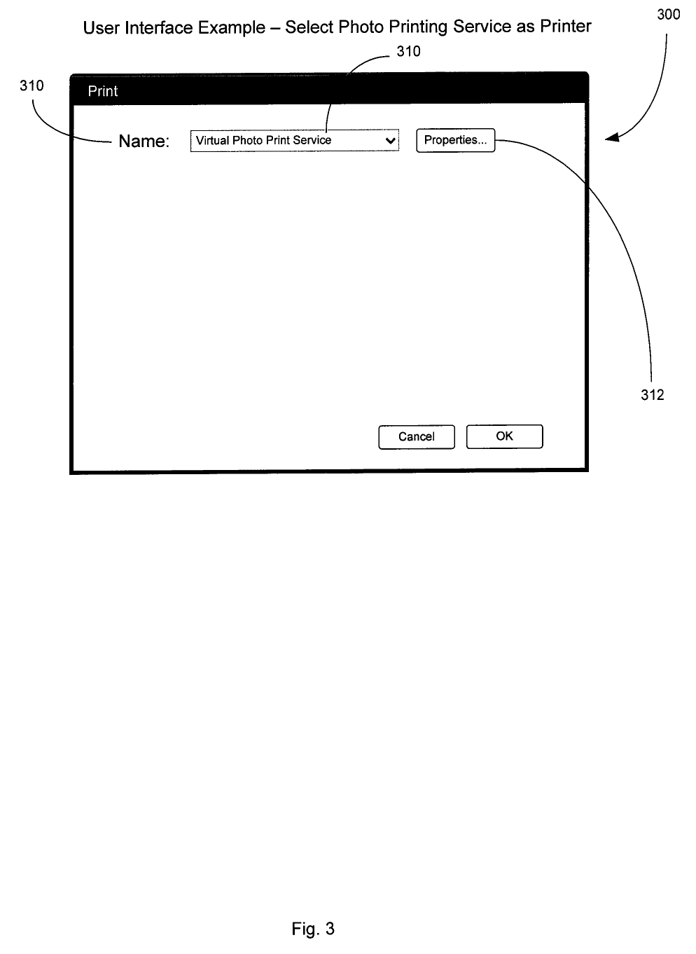

In certain aspects, a server side database provides over a network to the printer driver print-service information 300 such as a directory of the user selectable print services 310 as well as service parameters 312 (e.g. supported file types and URLs) for each available print service as shown in FIG. 3. In other aspects, such print service information is pre-loaded on the printer driver. The print service information 300 may also include a still image along with the user selectable services 310 such that a user can see more information about a virtual printer photo service before making a selection. The virtual printer driver will present to a user all or a portion of the print service information 300, e.g. available service locations 312, and provide menu tools for navigating through the selections.

Referring back to FIG. 1, the overall method of operation, including uploading and processing, is illustrated. There are several benefits of the virtual printer driver 110 including ease of use, background uploading/processing, and file compatibility when compared to current methods of photo printing. For example, uploads 112 can be accomplished using a common network file transfer protocol, FTP, or other protocols to transfer a file from a customer computer 101 and the virtual printer driver 110.

Ease of Use. Referring further to FIG. 1, a method of uploading image files is shown. Instead of going through the steps of uploading the image files to a print service website, which is often a slow process due to bad website workflow, and slow webpage loading time, the user simply selects the virtual printer driver 110, and prints the photos just like printing to a real printer by utilizing the photo printing service server 140.

Background processing. Referring further to FIGS. 1 and 2, uploading to the websites is often time-consuming because of slow internet connection. If the user has multiple photos to print, he must wait until all photos are uploaded. With the virtual printer driver 110, 220, in certain aspects, the printer driver module 110, 220 executes as a background process such that the image files are uploaded to the print service 140 in the background with the printing spooler 240. Thus, the user can immediately turn his/her attention to other matters and does not have to wait until uploading has ended.

Application compatibility. Since this functionality is implemented as a printer driver, it is compatible with all applications with printing functionality 210 as illustrated in FIG. 2. The user has the choice of using the application of their preference.

File format compatibility. All web photo printing services have some kind of limitations on the file format they support. Thus, if the user is working on a file which is not supported, he must export to a supported format first. For example, if a photographer is working on a Photoshop file, he cannot simply upload the Photoshop PSD file for printing. Instead, he would have to export to a JPEG format first. With the virtual driver, the driver saves or converts the printing data into a supported format (typically JPEG), without any additional steps from the user.

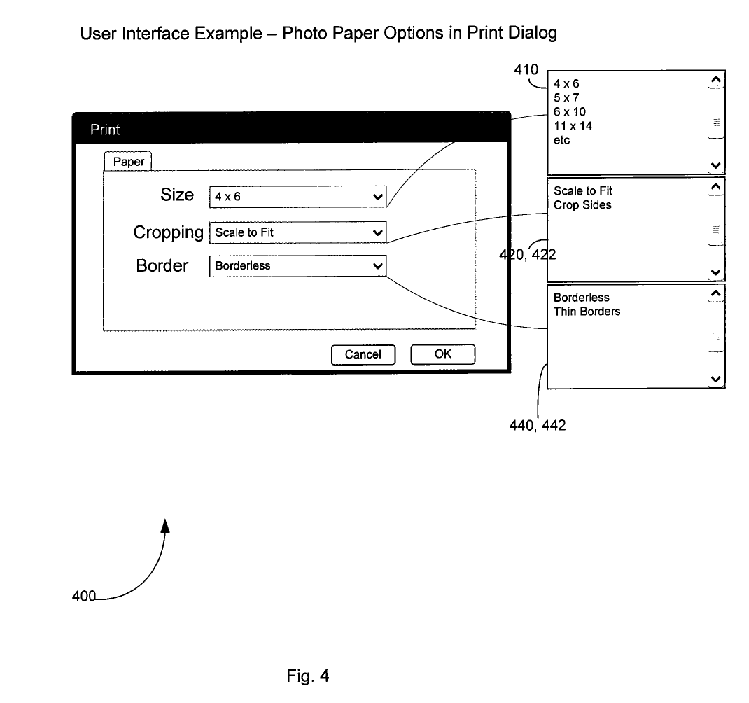

FIG. 4 illustrates an embodiment including a user interface example showing photo paper options in a print dialog view 400. The photo paper options client interface 400 allows a user to select paper size 410 (e.g. 4×6, 5×7, 8×10, 11×17 and other sizes), cropping 420, and border 440. One cropping option 420 includes by way of example scale to fit 422. One border option 440 includes by way of example borderless 442. Once a user has specified all of the photo paper options in the photo paper options client interface screen 400, the data may be entered and a new screen entered.

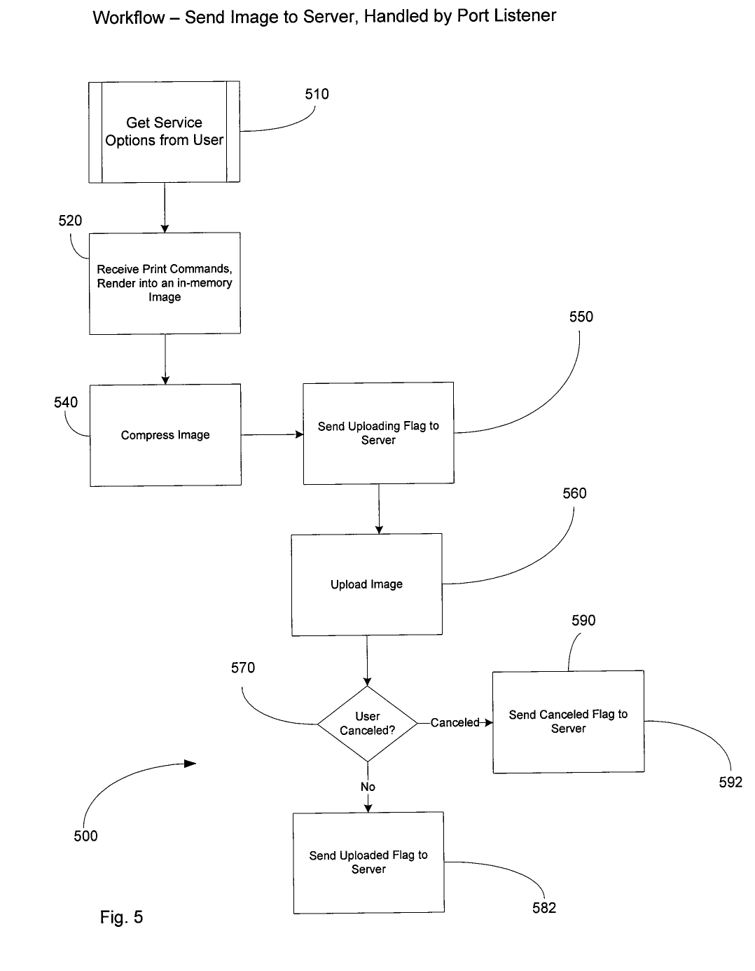

FIG. 5 illustrates an embodiment including a method to send an image to a server, handled by a port listener 500. In step 510, service options are obtained from the user. In step 520, print commands are received and rendered into an in-memory image. In step 540, the images are compressed for transmission. Step 550 sends an uploading flag to the server to upload the images 560. In step 570, the job sends an uploading flag 582 to the server if the job is not canceled 580 or sends a cancelled flag 592 to the server if the job was cancelled 590.

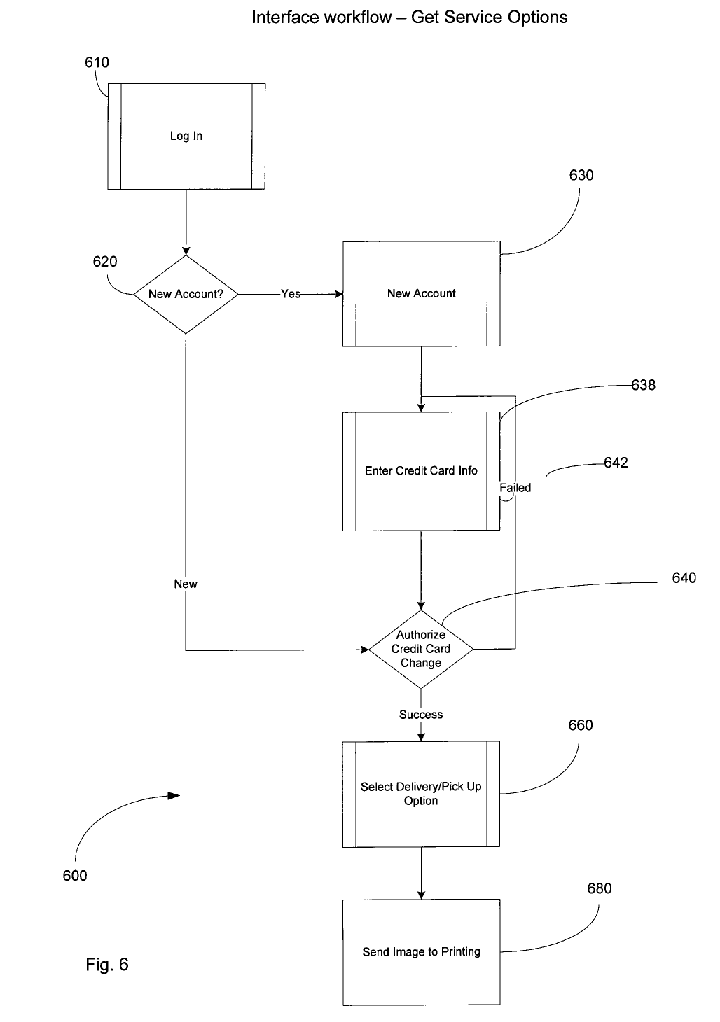

FIG. 6 illustrates an embodiment of an interface method to obtain service options 600. Initially, a log-in step is initiated 610 and classified as to whether it is a new account 620. If not, then a credit card is directly authorized 640 from information already on file. If the account is new, then a new account dialog box appears 630 where credit card information is entered 638. If the authorization of the credit card fails 642, then a new credit card information is obtained. Once the credit card authorization is complete 640, a delivery pick up option is selected 660 and images sent to a printing service location for actual printing 680.

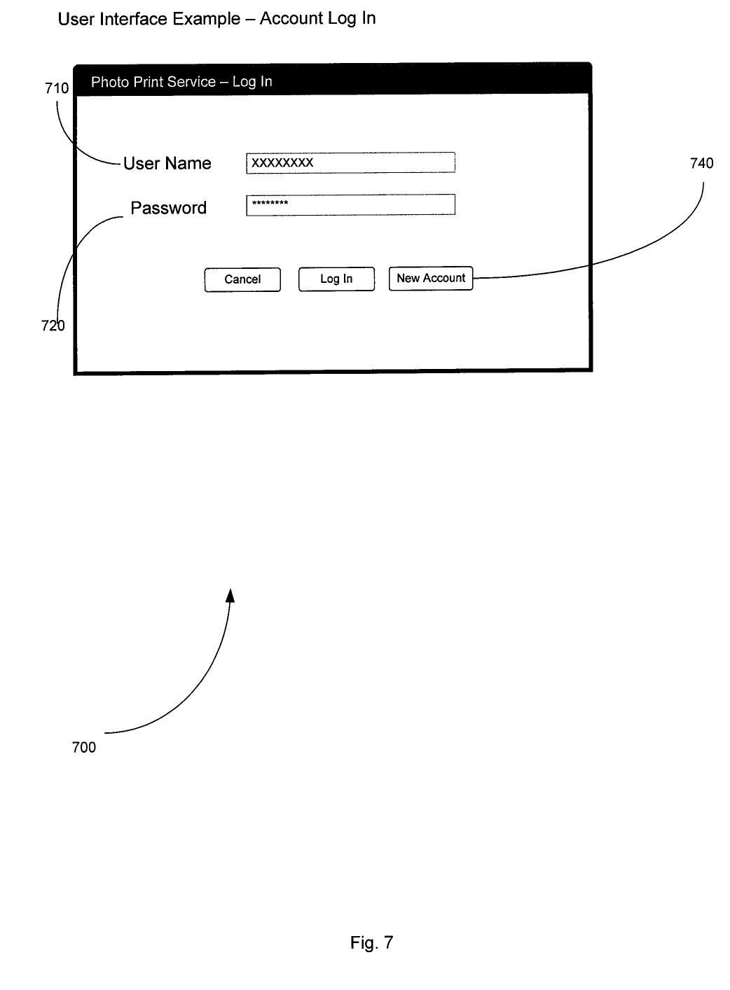

FIG. 7 shows an embodiment including a user interface screen shot of a method to log in to an account. The account log in client interface 700 allows a user to enter a user name 710 and a password 720 if the user has an existing account. A method is also shown to allow a user to create a new account 740. Further, other similar fields may be included as desired in certain aspects of various embodiments of the new account client interface screen 700.

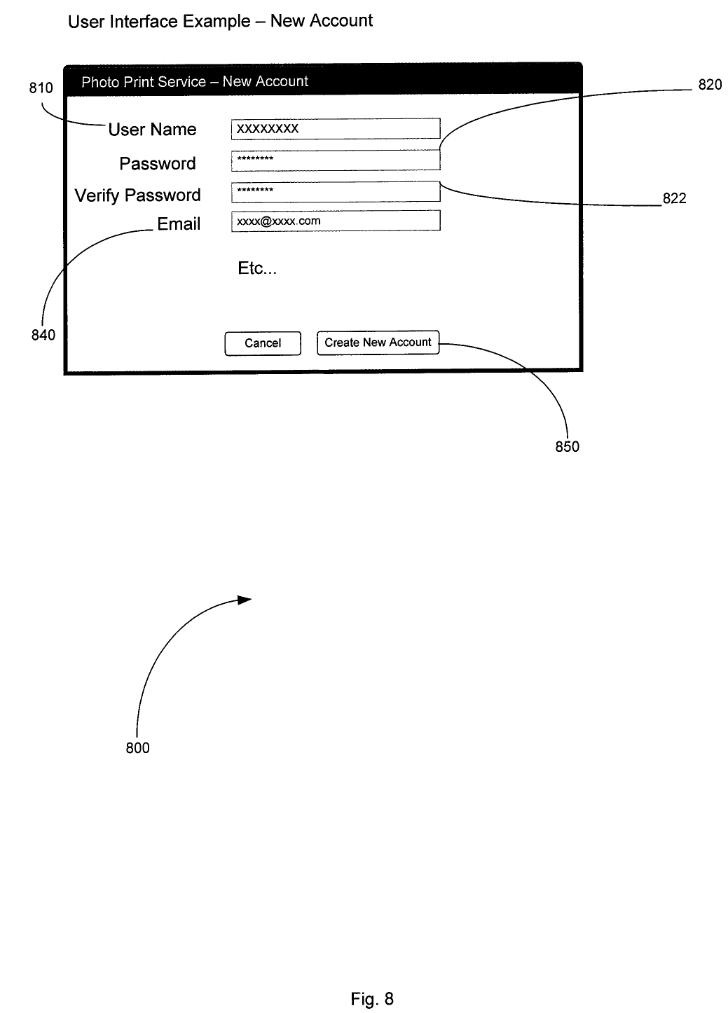

FIG. 8 shows an embodiment including a user interface screen shot of a method to create a new account. The new account client interface screen 800 requires a new user to create a user name 810, password 820, verify password 822, and link the user information to an e-mail address entry 840. Also, a new account button may be included in certain aspects of the embodiment 850. Further, other similar fields may be included as desired in certain aspects of various embodiments of the new account client interface screen 800.

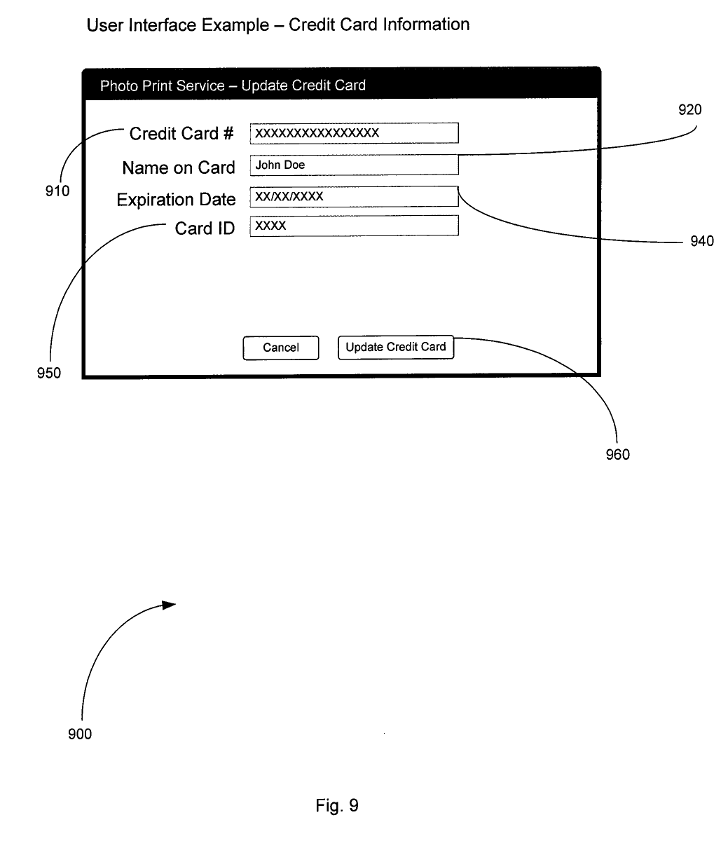

FIG. 9 shows an embodiment including a user interface screen shot of a method to enter a user credit card information 900. The credit card information client interface screen 900 allows a user to enter a new credit card number 910, name as shown on card 920, expiration date field 940, and card identification number 950. The entry confirmation is confirmed with a screen button with a message such as “Update credit card” 960. Further, other similar fields may be included as desired in certain aspects of various embodiments of the credit card information client interface screen 900.

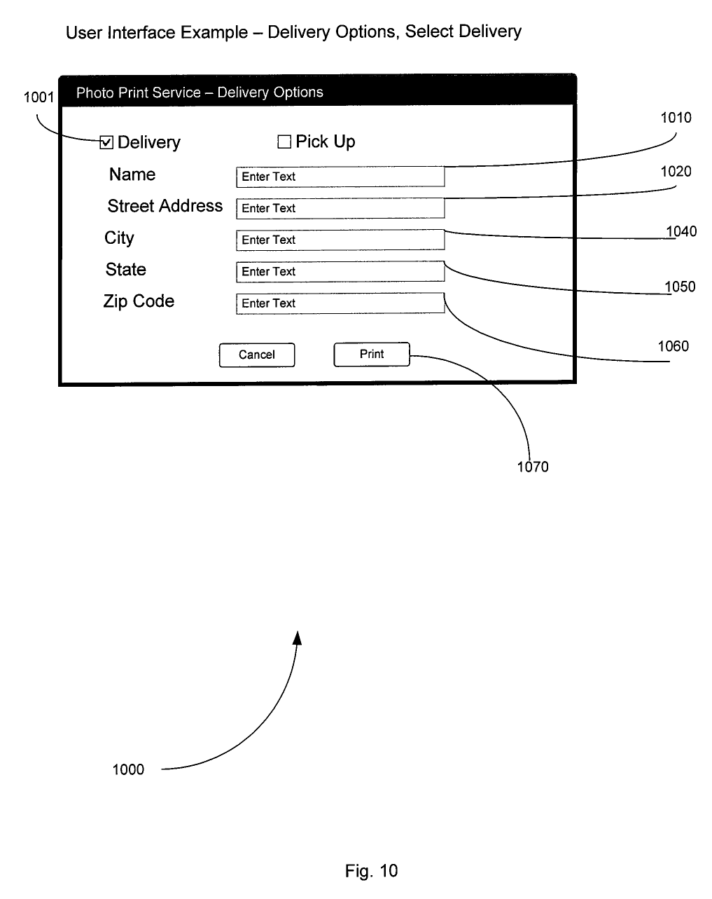

FIG. 10 shows an embodiment including a user interface screen shot 1000 of a method to enter a delivery option to have photos delivered to a specified location. The delivery options client interface screen 1000 allows a user to enter a user name 1010, street address 1020, city field 1040, state 1050, and zip code 1060. The entry confirmation is confirmed with a screen button with a message such as “Print” 1070. Further, other similar fields may be included as desired in certain aspects of various embodiments of the delivery options client interface screen 1000.

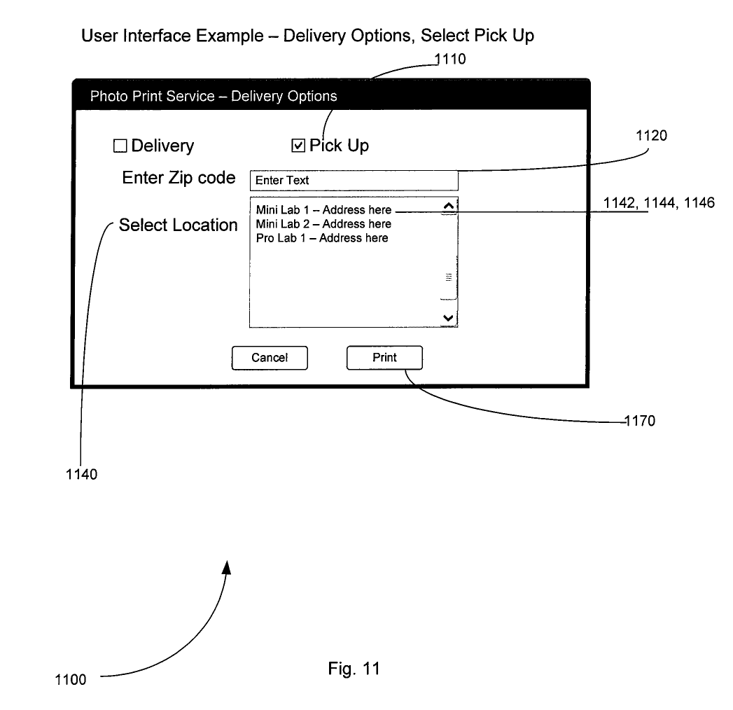

FIG. 11 shows an embodiment including a user interface screen shot of a method to enter a delivery option to have photos picked up by a user or third party at a specified location 1100. The delivery options pick up selection client interface screen 1100 allows a user to enter a pick up option 1110, zip code 1120, city field 1142, state 1144, and zip code 1146 corresponding to a drop down list of pick up location selections 1140. The entry confirmation is confirmed with a screen button with a message such as “Print” 1170. Further, other similar fields may be included as desired in certain aspects of various embodiments of the delivery options pick up selection client interface screen 1100.

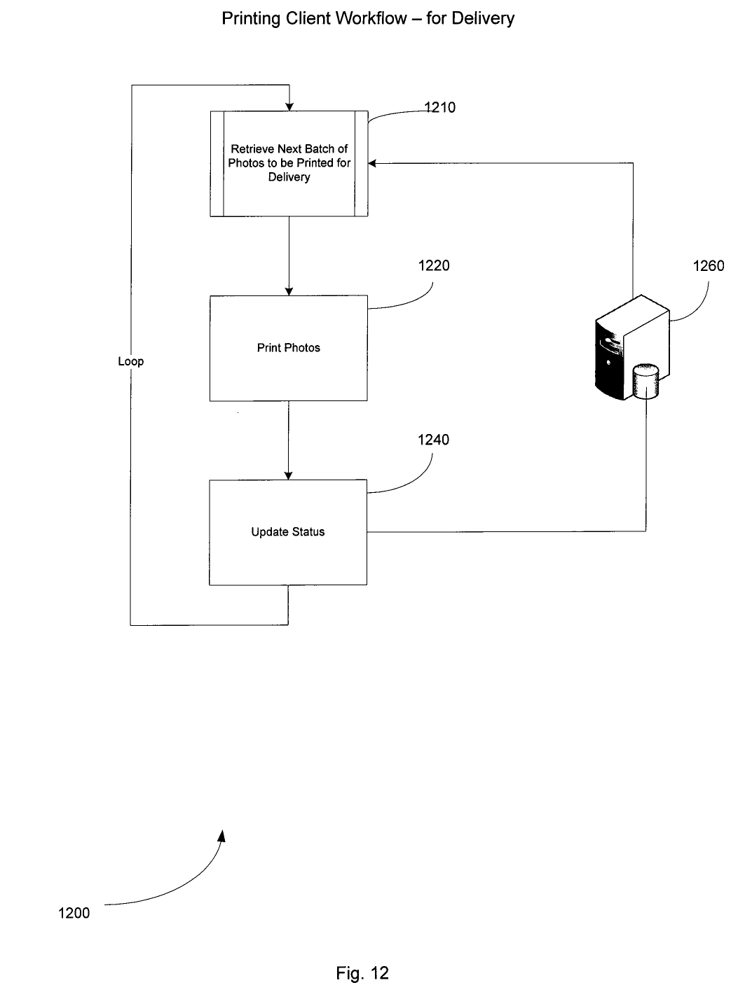

FIG. 12 illustrates a method of client printing wherein the specified photos are delivered to a user specified location 1200. In step 1210, a batch of photos to be printed for delivery are retrieved. In step 1220, the photos are actually printed and step 1240 the status of the print job is updated and a corresponding message is sent to the print service server 1260. Finally, the print service server sends a query to retrieve the next batch of photos to be printed for delivery and step 1210 is repeated as required.

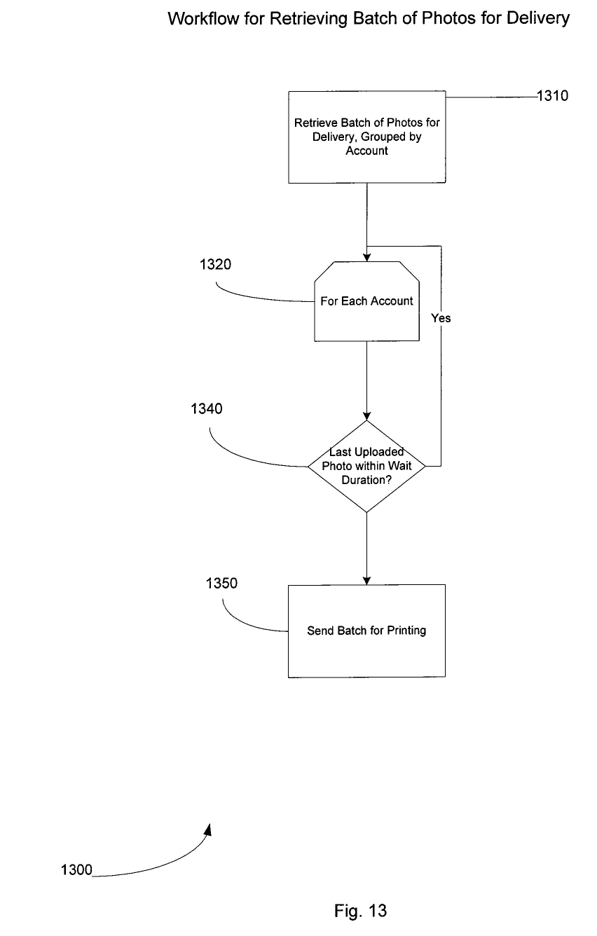

FIG. 13 illustrates a method of retrieving a batch of photos for delivery to a user specified location 1300. The overall method of retrieving a batch of photos for delivery 1300 begins in step 1310 by each retrieved batch of photos being grouped by a common account 1320. In step 1330, the record retrieval record is examined to determine whether the last uploaded photo batch is within the user specified wait duration 1340. If not, then the batch is sent to the print service server for printing 1250. If the last uploaded photo batch is within the user specified wait duration then the query returns for newly uploaded photos in common with the account information 1320 and the process is repeated in steps 1320 and 1330.

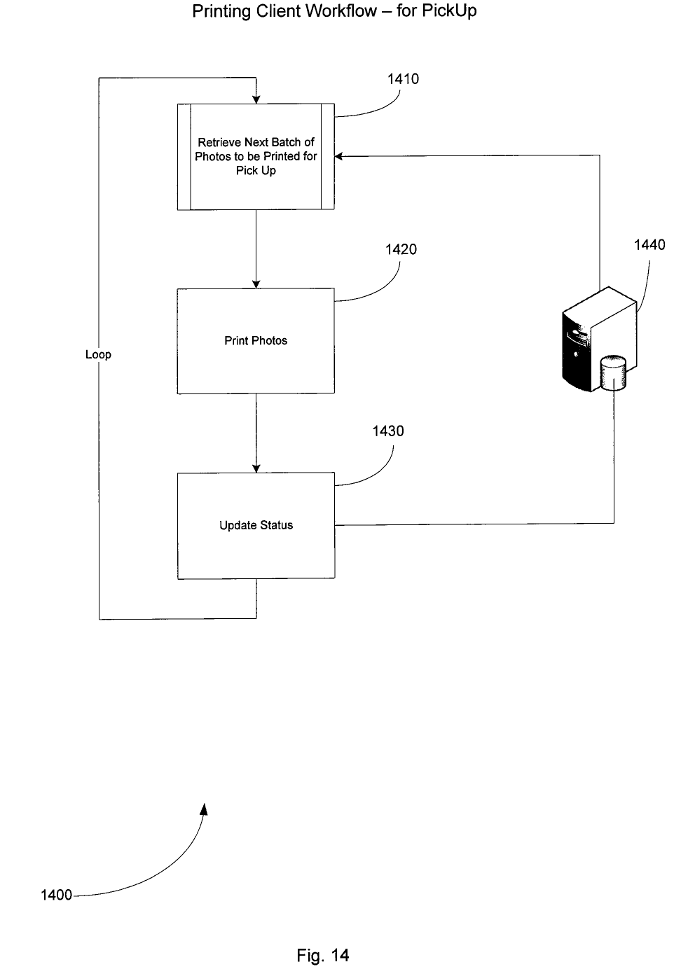

FIG. 14 illustrates a method of client printing wherein the specified photos are available for user to pick up at a specified location 1400. A similar method as that shown in FIG. 13 is illustrated in FIG. 14. In step 1410, the next batch of photos to be printed for pick up is identified by the print service server. In step 1420, the photos are actually printed and step 1430 updates the print job status and returns to step 1410 to retrieve the next batch of photos and also sends a message to the print service server database to update records 1440.

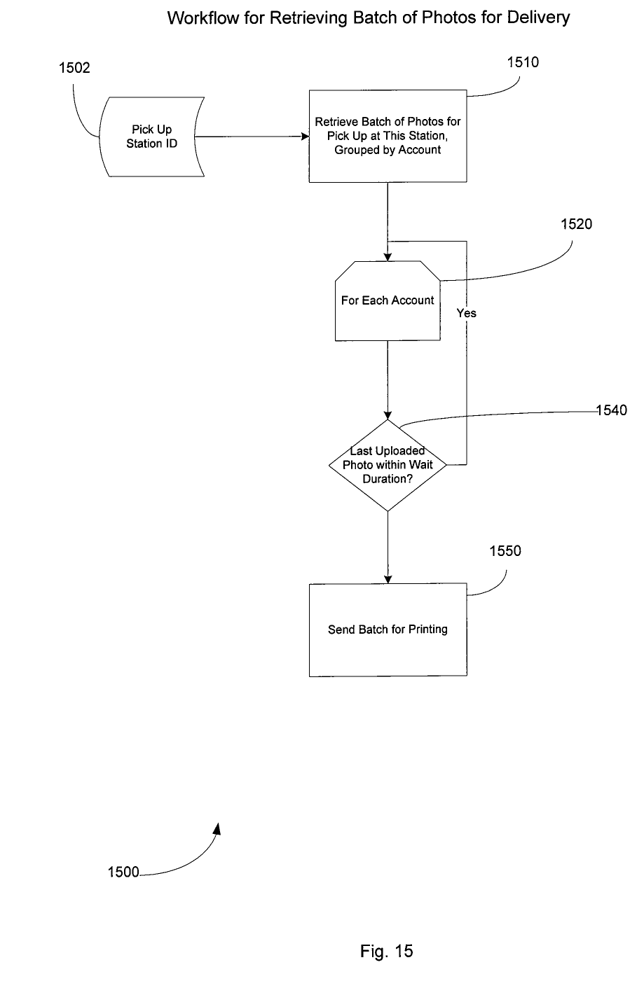

FIG. 15 illustrates a method of retrieving a batch of photos for delivery upon receiving a message from a pick-up station ID. The overall method of retrieving a batch of photos for delivery 1500 begins in step 1502 by assigning a pick up station identification and in step 1510 by each retrieved batch of photos being grouped by a common account 1520. In step 1530, the record retrieval record is examined to determine whether the last uploaded photo batch is within the user specified wait duration 1540. If not, then the batch is sent to the print service server for printing 1550. If the last uploaded photo batch is within the user specified wait duration then the query returns for newly uploaded photos in common with the account information 1520 and the process is repeated in steps 1520 and 1530.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of sending image files to a remote photo printing service from a client device, said client device storing one or more image files, the method comprising:
a) providing a virtual printer driver module, wherein the printer driver module executes on a processor of the client device;
b) receiving, at the printer driver module, a user input print job request identifying one or more digital image files and a printing service; and
c) uploading the one or more digital image files to the photo printing service over a network connection using the virtual printer driver module.

2. The method of claim 1, further comprising printing said digital image files at the photo printing service provider.

3. The method of claim 1, wherein uploading executes as a background process.

4. A computer readable medium comprising:
program code for providing a printer driver module, wherein the printer driver module executes on a processor of the client device;
program code for receiving, at the printer driver module, a user input print job request identifying one or more digital image files and a printing service; and
program code for uploading the one or more digital image files to the photo printing service over a network connection using the printer driver module.

5. The computer-readable medium of claim 4 for sending image files to a remote photo printing service from a client device, said client device storing one or more image files.

6. A client system comprising a processor and a computer readable medium of claim 4, wherein the processor executes the program code.

7. A computer system for providing a virtual photo printing service, the system including a memory containing predetermined instructions and one or more data structures, a processing unit operatively coupled to the memory and capable of executing the predetermined instructions, an output device operatively coupled to the memory and the processing unit, wherein the processing unit executes the predetermined instructions to:
a) provide a printer driver module;
b) receive, at the printer driver module, a user input print job request identifying one or more digital image files and a printing service; and
c) upload the one or more digital image files to the photo printing service over a network connection using the printer driver module.

8. The method of claim 1, further including converting the digital image file to one of a bmp, jpeg, or tiff file prior to uploading, and wherein uploading includes sending the bmp, jpeg, or tiff file to a server associated with the photo printing service.

9. The method of claim 1, further including directly encoding and uploading a digital image file such that no file formatting or exporting is required.

10. The method of claim 1, further comprising:
providing physical photo printing services wherein the print commands execute a set of printing instructions via a print command language on a print spooler and a port listener; and
executing the physical photo printing services independently of the uploaded file format.

11. The method of claim 10 wherein the physical photo printing services comprises one or more print jobs that execute as a background process.

12. The method of claim 11, further comprising:
providing a means of selection of one or more print jobs from a pending print job menu; and
canceling the print job in response to a user selection.

13. A system for accessing a photo print service through a printer driver, comprising:
a client interface device including one or more processors executing instructions stored in one or more memory files;
a display device for providing a plurality of user-selectable print configurations;
one or more input/output peripheral devices for associating data with a set of user commands and/or configurations;
a virtual photo printer driver connected via a network communications medium, and configured to send a plurality of print commands to a print service server over the network communications medium;
the server communicatively coupled to a database repository, and
wherein the print service server is configured to provide physical photo printing services wherein the print commands execute a set of printing instructions via a print command language on a print spooler and a port listener, wherein the physical photo printing services are executed independent of the uploaded file format.

14. The system of claim 12, further comprising:
the print commands including a menu of images that are encoded and uploaded to the virtual photo printer driver, server and print service site.

15. The system of claim 12 wherein the port listener translates the print commands from the print language via a plurality of communication protocols such that physical photo printing services are provided directly in the desired image file format.

16. The system of claim 14 further comprising:
the print service site wherein any image or viewing application file format is supported to execute physical photo printing services.
